(19) United States
(12) Patent Application Publication
(10) Pub. No.: US 2007/0222214 A1
(43) Pub. Date: Sep. 27, 2007

(54) Spin weld water attachments

(76) Inventor: Gary Klinger, Rochester Hills, MI (US)

Correspondence Address: YOUNG & BASILE, P.C., 3001 WEST BIG BEAVER ROAD, SUITE 624, TROY, MI, 48084, US

(21) Appl. No.: 11/388,406

(22) Filed: Mar. 24, 2006

(51) Int. Cl. F16L 13/02

(52) U.S. Cl. 285/288.1

(57) ABSTRACT

A fluid coupling between first and second fluid carrying components is formed by spin welding. The first fluid carrying component can have a bore with an inner surface defining an inner weld surface. The second fluid carrying component can have a fluid passage between a first and a second opening. The second fluid carrying component can have an endform having an outer weld surface. The second fluid carrying component endform can be adapted to insert into the first fluid carrying component bore. The two fluid carrying components are sealingly joined by a spin weld formed between the outer weld surface and the inner weld surface. Alternatively, the second fluid carrying component can include an annular recess adapted to receive the first fluid carrying component, creating an additional inner weld zone in the recess.

### BACKGROUND

The subject invention relates to fluid connectors and, more particularly, to the sealing interconnection of such connectors with tubing endforms and, more particularly still, the use of spin welding to effect such interconnection.

Generally rigid pipes, such as hard copper pipes, are commonly used in the plumbing industry. However, the use of pliable hose or tube material provides for optimal flexibility when routing water pipes in homes or buildings. But the use of traditional compression collars for connecting more flexible conduit creates a difficulty in attaining connection points. One cost effective design is the plastic housing female type quick connector releasably mated to a male tube endform. The opposite end of the female connector body most typically defines a stem having a member of axially spaced barbs formed on the outer circumferential surface thereof and a nylon or plastic tubing endform pressed there over. Such an arrangement is described in U.S. Pat. No. 5,542,712.

In fluid handling systems, it is imperative that the connectors used have first and second fluid carrying components portions properly coupled together. A faulty connector enables an associated system to leak fluid. This can be particularly disadvantageous when the system is under pressure and the leaking connector expels the pressurized fluid.

A related problem stems from dual aspects of commercially available quick connect devices, to with: high volume and low sale price frequently necessitating the use of inexpensive, somewhat pliable materials, and complex contours of extremely small inter-fitting components. These aspects collectively increase the likelihood of misassembly. High volume production techniques, including automated assembly tends to aggravate the problem wherein misassembly or impermissible dimensional variations of the components are difficult to detect. Excessive dimensional tolerance stack-up can result in low pull-apart characteristics between the barbed stem and the plastic tube and produce leakage. Misassembly, such as failure to include an O-ring, can also result in leakage. In the case of multi-layer tubes, dimensional and/or adhesive problems can result in mechanical delamination upon insertion of the tube over the barbed stem. Finally, mono-wall plastic tube or multi-layer structures with low hoop strength can relax over time or at elevated temperatures, resulting in leaking or weeping of fluid.

### SUMMARY

The present invention provides a simple and inexpensive watertight connection between a tube end and a connector body.

In one aspect, the present invention is a fluid coupling formed of spin weld joined first and second fluid carrying components. The first fluid carrying component can be formed of a tubular member having a through bore extending from a leading edge. The second fluid carrying component can be formed of a connector body having a fluid passage extending from a first opening to a second opening and an endform with an outer weld surface configured to be inserted into the bore of the first fluid carrying component. The first fluid carrying component is permanently affixed to the second fluid carrying component by spin welding. A spin weld inducing bonding material layer can be disposed on the outer weld surface of the connector body to spin weld join the first component to the second component.

In another aspect, the present invention is a method of fluid coupling first and second fluid carrying components. The method comprises the steps of positioning a first fluid carrying component, such as a tubular member, having a through bore extending from a leading edge, to receive a second fluid carrying component, such as a connector body, having a fluid passage extending from a first opening to a second opening and an endform with an outer weld surface; aligning the bore of the tubular member concentrically with the fluid passage of the connector body; inserting the endform of the connector body into the bore of the tubular member; and spin welding the first and second fluid carrying components causing the material to sealingly join the tubular member and the connector body.

The outer weld surface can be terminated by a radially extending flange having an end wall positioned a distance from an edge of the connector body. A collar having a diameter substantially equal to the diameter of the tubular member can be located adjacent to the end wall of the flange. The endform of the connector body can be inserted into the bore of the tubular member until the leading edge contacts the collar.

Alternatively, the endwall of the flange can include an annular recess configured to receive the leading edge of the tubular member. The method can include the step of engaging the leading edge of the tubular member into the annular recess.

The spin weld fluid coupling and method of making the same of the present invention provides a spin weld coupling between two fluid carrying components which uniquely enables the use of materials forming the first and second components to be spin welded together in a permanent, secure, leak-free joint.

### BRIEF DESCRIPTION OF THE DRAWING

The various features, advantages, and other uses of the present invention will become more apparent by referring to the following detailed description and drawing in which:

FIG. 1 is a perspective view of a first fluid carrying component in accordance with the present invention;

FIG. 2 is a side-elevation view of the first fluid carrying component shown in FIG. 1;

FIG. 3 is a sectional side-elevation view of the first fluid carrying component in FIG. 1 spin welded to the second fluid carrying component;

FIG. 4 is a perspective view of an alternative configuration of the first fluid carrying component shown in FIG. 1;

FIG. 5 is a side-elevation view of the alternative configuration of the first fluid carrying component shown in FIG. 4;

FIG. 6 is a sectional view of the alternative configuration of the first fluid carrying component shown in FIG. 4 spin welded to the second fluid carrying component; and

FIG. 7 is an enlarged, partial view of the annular recess of the first fluid carrying component portion of the fluid coupling illustrated in FIGS. 5-6.

### DETAILED DESCRIPTION

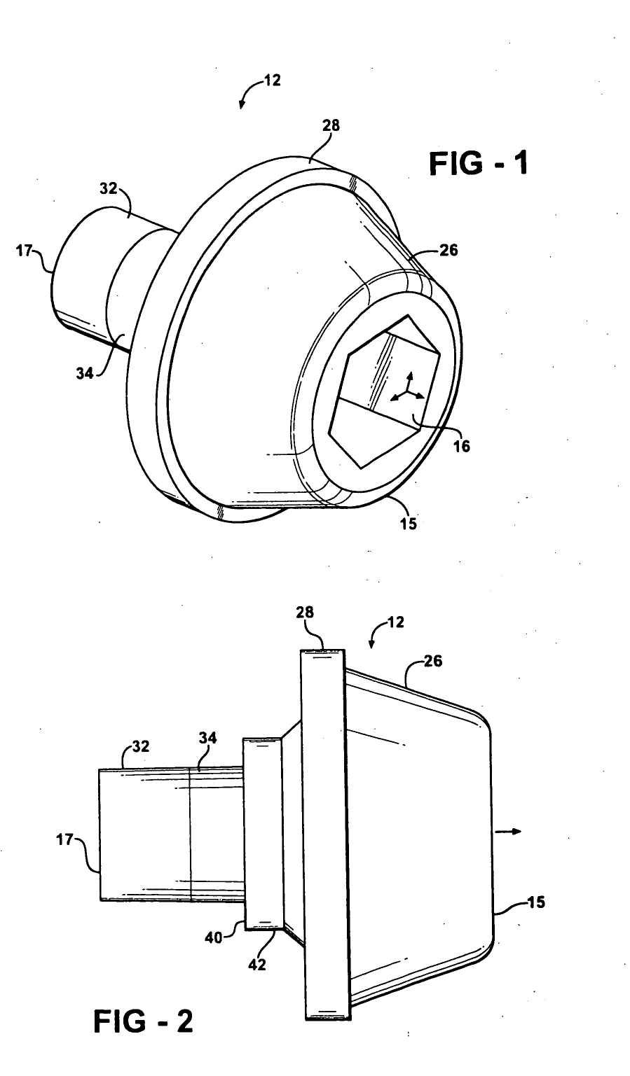

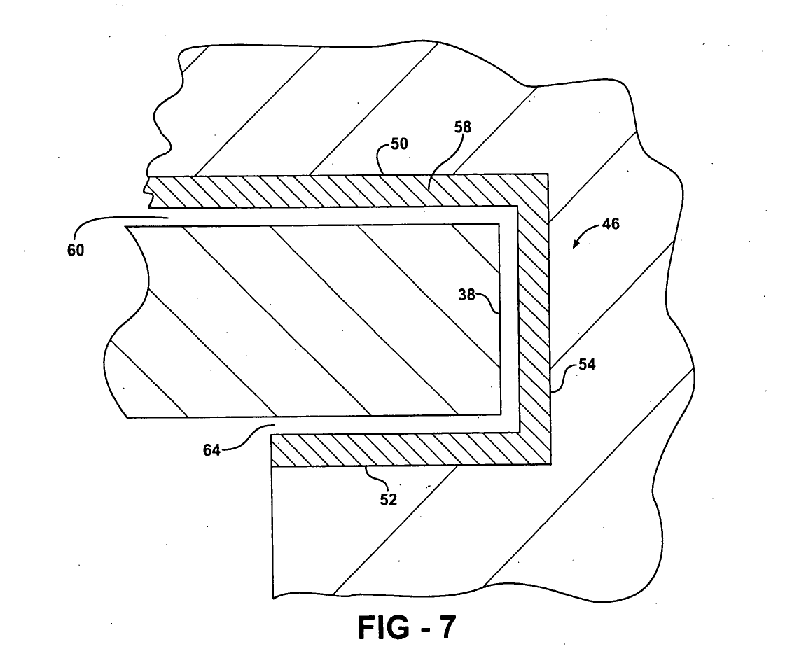

Referring to FIGS. 1-8, two aspects of the present invention is illustrated in an application comprising a fluid coupling in which a connector serves to permanently interconnect fluid carrying components to effect a fluidic circuit, preferably for use in plumbing applications.

It will be understood that the fluid coupling uses the illustrated tubular member 20 by way of example only. Alternately, the fluidic coupling of the present invention may be embodied in a configuration applied to other standard plumbing elements.

As illustrated in FIGS. 1-6, the coupling assembly 10 includes a hard plastic first fluid carrying component, such as a plastic tubular member 20 having a through bore 22 and a second fluid carrying component, such as a connector body 12 formed of a suitable material having a first end 15 and a second end 17 and a fluid passage 14 extending therethrough from a first opening 16 located at the first end 15 to a second opening 18 located at the second end 17. The inner surface 24 of the fluid passage 14 of the connector body 12 can be stepped between the first opening 16 and the second opening 18. The first opening 16 of the fluid passage 14 can define a polygonal shaped inner surface 24. An outer surface 26 can be configured for sealing engagement with a complimentary seat formed in a fluid operative device. As shown, the outer surface can be of a conic configuration adapted to watertightly abut against the complimentary seat of a fluid operative device, not shown, to prevent fluid leakage.

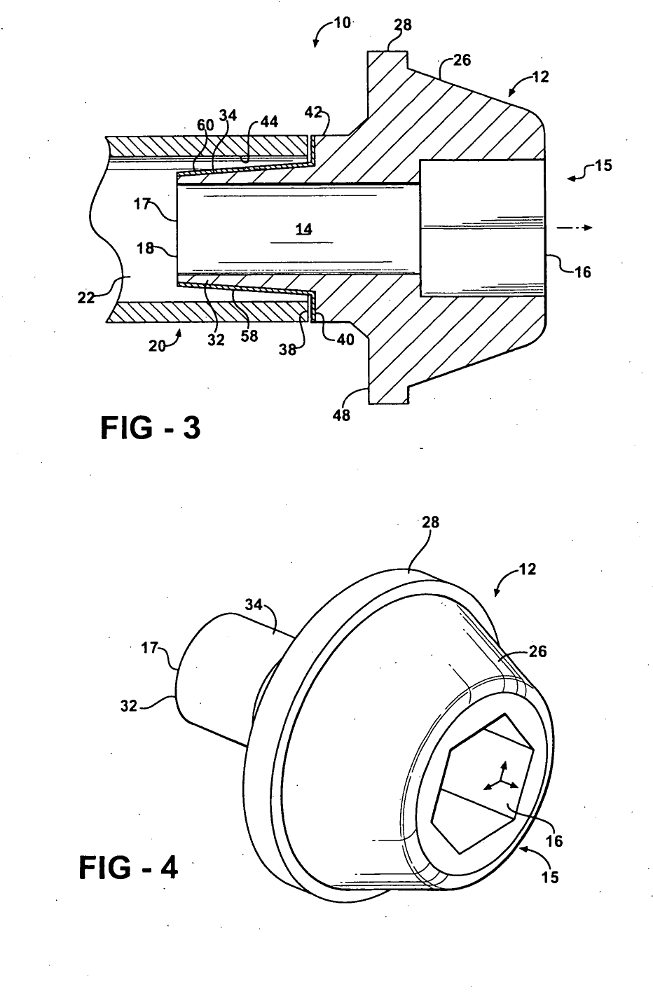

An annular flange 28, located intermediately between the first 15 and second ends 17, extends radially outward from the outer surface 26 of the connector body 12. An endform 32 and an outer peripheral surface 34 of the endform 32 are defined between the second end 17 and the annular flange 28. The outer surface 34 of the endform 32 defines an outer weld surface of the connector body 12. The endform 32 of the connector body 12 can be adapted to be inserted into the bore 22 through a first opening of the tubular member 20 as shown in FIGS. 3 and 6. The outer surface diameter 34 of the connector body endform 32 may be non-uniform, such as conical or tapered, to provide a lead-in feature to enhance the insertion of the connector body endform 32 into the bore 22 of the tubular member 20. Referring to FIG. 3, the connector body endform 32 can be inserted into the tubular member bore 22. A leading edge 38 of the tubular member 20 can engage with an end surface 40 of a collar 42. The collar 42 can extend radially outward from the outer weld surface 34, adjacent an end wall 48 of the annular flange 28, a distance from the second opening 18. The outer weld surface 34 of the connector body endform 32 can be permanently affixed to an inner weld surface 44 of the tubular member bore 22 by spin welding.

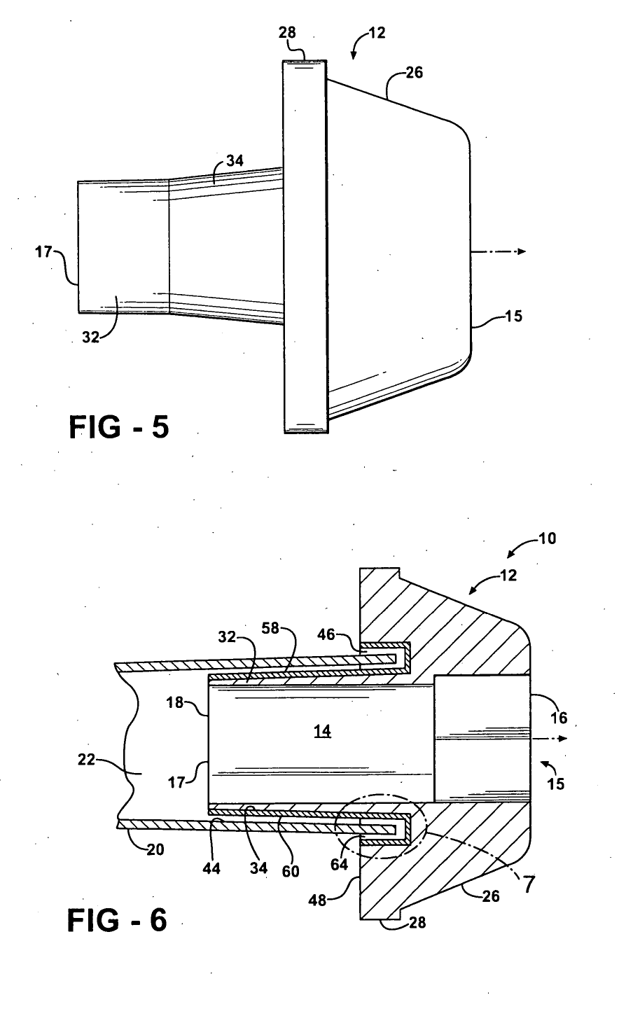

Alternatively, as shown in FIGS. 5, 6 and 8, the connector body 12 can include an annular recess 46 formed in the end wall 48 of the annular flange 28. The annular recess 46 can be adapted to receive the leading edge 38 of the tubular member 20. The recess 46 forms an annular groove or open ended slot formed of a radially inner recess surface 50, a radially outer recess surface 52 and an inner end wall 54. The connector body endform 32 can be inserted into the tubular member bore 22 and the leading edge 38 of the tubular member 20 can be inserted into the annular recess 46. The outer weld surface 34 and the inner weld surface 44, as well as the annular recess surfaces 50, 52, 54 and the leading edge 38, can be permanently joined by spin welding.

At least one and, optionally, all three of the radially inner recess surface 50, the radially outer recess surface 52 and the inner end wall 54 can be covered with a bonding material layer 56 which is spin weld compatible with both of the materials on the outer surface 34 of the endform 32 and tubular member 20. For example, SANOPRENE may be employed as a spin weld inducing bonding material.

The bonding material is applied to the recess surfaces 50, 52, 54 by suitable means, which may include double shot injection molding during injection molding of the connector body 12. The double shot injection molding process insures that all of the surfaces are covered with the bonding material.

Alternately, the bonding material may be inserted into the recess 46 by other techniques. In one aspect, the bonding material may be fixtured in a loose form on any or all the surfaces. During the spin welding of the tubular member 20 relative to the connector body 12, the loose bonding material melts and then solidifies to fuse the elements together.

The bonding material is applied to the surfaces in a thickness to form an opening between opposed surfaces of the bonding material in the recess 46 which is capable of easily receiving the sidewall thickness of the leading edge 38.

The tubular member 20 can be formed of a plastic tube or conduit having an inner surface. For example, one multi-layered tubular member 20 may include a fluoropoylmer inner-layer, a NYLON outer-layer and an intermediate layer 58 of adhesive such as an Admer adhesive to bond the two layers together. The same adhesive may be used as a compatibilizer or as a spinweld inducing material applied to the inner services of the recess.

Alternately, the compatibilizer or spinweld inducing bonding material may be a NYLON 6/12 disposed on the surfaces in the recess between a NYLON 12 fluid connector endform and a NYLON 6 tube member. The connector endform can alternately be formed of NYLON 6 and the tube member formed of NYLON 12, with the same NYLON 6/12 compatibilizer.

Referring to FIGS. 3 and 6, the spin welding process of joining the tubular member 20 and the connector body endform 32 is illustrated. As shown, the endform 32 is pre-positioned and aligned concentrically with the bore 22 of the tubular member 20.

The connector body endform 32 may be mounted rigidly and the tubular member 20 mounted for relative rotation therewith in a suitable press, for example. As shown in FIG. 3, once a suitable speed differential is established, the tubular member 20 and the connector body endform 32 can be axially pressed together until the leading edge 38 of the tubular member 20 contacts the end surface 40 of the connector body collar 42. The engaged surfaces generate friction, partially melting and fusing the materials of the two components together, at which time all relative axial and rotational displacement ceases. Alternatively, as shown in FIG. 6, the tubular member 20 and the connector body endform 32 can be axially pressed together until the leading edge 38 of the tubular member 20 contacts the inner surfaces 50, 52, 54 of the annular recess 46 in the flange 28.

The various control parameters in spin welding are generally well known, albeit in other applications. For the sake of brevity such parameters will not be repeated here, reference being made to U.S. Pat. Nos. 2,933,428; 3,980,248 and 5,152,855.

During the spin welding process, the inner weld surface 44 of the tubular member bore 22 frictionally engages the radially outer weld surface 34 of the connector body endform 32 to melt the surfaces thereof to a weldment zone 60. As shown in FIG. 6, the weldment zone can include an outer weld zone 60 located along the outer surface 34 of the endform 32 and an inner weld zone 64 located in the annular recess 46.

In conclusion, there has been disclosed a unique fluid coupling which uses a bonding material which is spin weld compatible with the materials outer surface 34 of the endform 32 and the tubular member 22 to ensure a sealed, leak free connection between the endform 32 and the tubular member 20. The unique quick connector and fluid coupling according to the present invention enable a flexible plastic tube 20 to be sealingly joined to a plastic connector body 12 via a spin welding process which ensures a complete 360° seal between the connector body 12 and the tubular member 20.

What is claimed is:

1. A fluid coupling comprising:
a first fluid carrying component having a through bore, the through bore having an inner surface extending from a leading edge, the inner surface defining an inner weld surface;
a second fluid carrying component having a fluid passage fluidically communicating with the through bore of the first fluid carrying component, the fluid passage extending between a first opening located at a first end and a second opening located at a second end, the second fluid carrying component having an endform with an outer surface, the endform adapted to insert into the bore of the first fluid carrying component; and
a spin weld formed between the inner weld surface of the first fluid carrying component and the outer surface of the second fluid carrying component, sealingly joining the first fluid carrying component and the second fluid carrying component.

2. The fluid coupling of claim 1 wherein the second fluid carrying component further comprises:
an annular flange extending outward from the outer surface of endform of the second fluid carrying component spaced a distance from the second opening, the annular flange having an end wall;

3. The fluid coupling of claim 2 wherein the outer surface of the second fluid carrying component further comprises:
an outwardly extending collar having an outer diameter substantially equal to the diameter of the first fluid component, the collar adjacent the end wall of the annular flange and spaced a distance from the second end on the outer surface of the endform, the leading edge of the first fluid carrying component engageable with the collar.

4. The fluid coupling of claim 1, wherein the second fluid carrying component further comprises:
a bonding material spin weld compatible with the material of the first and second components affixed to the outer surface of the endform.

5. The fluid coupling of claim 2 wherein the second fluid carrying component further comprises:
an annular recess formed in the end wall of the annular flange, the annular recess having inner recess surfaces adapted for receiving the leading edge of the first fluid carrying component.

6. The fluid coupling of claim 5, wherein the annular recess further comprises:
a bonding material spin weld compatible with the material of the first and second components affixed to at least one of the inner recess surfaces.

5. The fluid coupling of claim 1 wherein the outer surface of the second fluid carrying component further comprises:
a uniform outer diameter along the longitudinal length of the endform.

6. The fluid coupling of claim 1 wherein the outer surface of the second fluid carrying component further comprises:
a varying outer diameter along a portion of the longitudinal length of the endform.

7. The fluid coupling of claim 1 wherein the fluid passage of the second fluid carrying component further comprises:
the first opening defining a polygonal inner surface.

8. The fluid coupling of claim 1 wherein the second fluid carrying component further comprises:
an outer surface adapted for sealing engagement with a complimentary surface formed in a fluid operative device.

9. A method of coupling a first fluid carrying component and a second fluid carrying component, the method comprising the steps of:
positioning a first fluid carrying component having a through bore extending from a leading edge for receiving a second fluid carrying component having a through passage interconnecting a first opening located at a first end and a second opening located at a second end and an endform adapted to insert into bore of the first fluid carrying component, the endform having an outer weld surface;
aligning the bore of the first fluid carrying component with the fluid passage of the second fluid carrying component;
inserting the second fluid carrying component endform into the bore of the first fluid carrying component; and
spin welding the first and second fluid carrying components to sealingly join the first and the second fluid carrying components.

10. The method of claim 9, further comprising the steps of:
providing the outer surface of the endform with an annular flange having an end wall;
providing an outwardly extending collar adjacent to the end wall of the annular flange, the collar spaced a distance from the second end on the outer surface of the endform; and
engaging the leading edge of the first fluid carrying component with the collar.

11. The method of claim 9, further comprising the step of:
fixing a bonding material spin weld compatable with the material of the first and second components to the outer weld surface of the endform.

12. The method of claim 9, further comprising the step of:
providing the outer surface of the endform with an annular flange having an end wall;
providing an annular recess in the end wall of the flange, the annular recess having inner recess surfaces adapted to receive the leading edge of the first fluid carrying component; and
engaging the leading edge of the first fluid carrying component in the annular recess.

13. The method of claim 9, further comprising the step of:
fixing a bonding material spin weld compatable with the material of the first and second components to at least one of the inner recess surfaces.

14. A fluid coupling manufactured by a process including the steps of positioning a first fluid carrying component having a through bore extending from a leading edge, for receiving a second fluid carrying component having an endform and a fluid passage interconnecting a first opening and a second opening; aligning the bore of the first fluid carrying component concentric with the fluid passage of the second fluid carrying component; inserting the second fluid carrying component endform into the bore of the first fluid carrying component; and spin welding the first and second fluid carrying components to sealingly join the first and the second fluid carrying components, the fluid coupling comprising:
the first fluid carrying component having a through bore, the through bore having an inner surface extending from a leading edge, the inner surface defining an inner weld surface;
the second fluid carrying component having a fluid passage fluidically communicating with the through bore of the first fluid carrying component, the fluid passage extending between a first opening located at a first end and a second opening located at a second end, the second fluid carrying component having an endform with an outer weld surface, the endform adapted to insert into the bore of the first fluid carrying component; and
a spin weld formed between the inner weld surface of the first fluid carrying component and the outer surface of the second fluid carrying component, sealingly joining the first fluid carrying component and the second fluid carrying component.

15. The fluid coupling of claim 14 wherein the second fluid carrying component further comprises:
an annular flange extending outward from the outer surface of endform of the second fluid carrying component spaced a distance from the second opening, the annular flange having an end wall;

16. The fluid coupling of claim 15 wherein the second fluid carrying component further comprises:
a radially outward extending collar adjacent the end wall of the annular flange, spaced a distance from the first end, the leading edge of the first fluid carrying component engageable with the collar.

17. The fluid coupling of claim 14, wherein the second fluid carrying component further comprises:
a bonding material spin weld compatible with the material of the first and second components affixed to the outer weld surface of the endform.

18. The fluid coupling of claim 15 wherein the second fluid carrying component further comprises:
an annular recess formed in the end wall of the flange, the annular recess having inner recess surfaces adapted for receiving the leading edge of the first fluid carrying component.

19. The fluid coupling of claim 18 wherein the second fluid carrying component further comprises:
an annular recess formed in the end wall of the annular flange, the annular recess having inner recess surfaces adapted for receiving the leading edge of the first fluid carrying component.

20. The fluid coupling of claim 14 wherein the outer surface of the second fluid carrying component further comprises:
a uniform outer diameter along the longitudinal length of the endform.

21. The fluid coupling of claim 14 wherein the outer surface of the second fluid carrying component further comprises:
a varying outer diameter along a portion of the longitudinal length of the endform.

22. The fluid coupling of claim 14 wherein the fluid passage of the second fluid carrying component further comprises:
the first opening defines a polygonal inner surface.

23. The fluid coupling of claim 14 wherein the second fluid carrying component further comprises:
an outer surface adapted for sealing engagement with a complimentary surface formed in a fluid operative device.

24. A fluid coupling comprising:
a tubular member having a through bore, the through bore having an inner surface extending from a leading edge, the inner surface defining an inner weld surface;
a connector body having a fluid passage fluidically communicating with the through bore of the tubular member, the fluid passage extending between a first opening and a second opening, the first opening defining a polygonal inner surface, the connector body having an endform with an outer weld surface, the endform adapted to insert into the bore of the tubular member, a bonding material spin weld compatible with the material of the first and second components affixed to the outer weld surface;
an annular flange extending outward from the outer surface of the connector body endform spaced a distance from the second opening, the annular flange having an end wall;
an outer surface on the connector body adapted for sealing engagement with a complimentary surface formed in a fluid operative device; and
a spin weld formed between the inner weld surface of the tubular member and the outer weld surface of the connector body, sealingly joining the tubular member and the connector body.

25. The fluid coupling of claim 24 wherein the connector body further comprises:
a radially outward extending collar adjacent to the end wall of the annular flange, spaced a distance from the second opening, the leading edge of the tubular member engageable with an end wall of the collar.

26. The fluid coupling of claim 24 wherein the connector body further comprises:
an annular recess formed in the end wall of the flange, the annular recess having inner recess surfaces adapted for receiving the leading edge of the tubular member.

27. The fluid coupling of claim 26 wherein the annular recess further comprises:
a bonding material spin weld compatible with the material of the first and second components affixed to at least one of the inner recess surfaces.
